(19) United States
(12) Patent Application Publication
(10) Pub. No.: US 2005/0223314 A1
(43) Pub. Date: Oct. 6, 2005

(54) System and method for automatic generation of presentations based on agenda

(75) Inventors: Sridhar Varadarajan, Bangalore (IN); Ravi Gururaj Amur, Bangalore (IN); Korrapati Kalyana Rao, Bangalore (IN)

Correspondence Address: Richard L. Byrne, 700 Koppers Building, 436 Seventh Avenue, Pittsburgh, PA, 15219-1818, US

(73) Assignee: SATYAM COMPUTER SERVICES INC.

(21) Appl. No.: 10/814,927

(22) Filed: Mar. 31, 2004

(51) Int. Cl. G06F 17/21

(52) U.S. Cl. 715/512; 715/511

(57) ABSTRACT

In enterprises, presentations are designed and made to visiting clients on a routine basis and it is expected that such presentations are required to be effective as much of business depends on right kind of information in right depth and volume made to right audience. The typically followed manual process depends on the capabilities of a person to create “right” presentation targeted for the right audience. It is required to obtain as much information as possible from such persons and use it to generate presentations as much automatically as possible. The automatic generation of presentation is based on (a) agenda; (b) audience profile; (c) analogical examples; and (d) templates. The system generates draft version of presentations and lets users to interactively tune the draft presentations to generate final version of the presentations. The analogical examples are identified manually and are made part of the system while the templates are automatically generated based on “best” presentations that are provided as input to the system.

### FIELD OF THE INVENTION

The present invention relates to the management of presentation material of an enterprise in general, and more particularly, automatic generation of presentation material. Still more particularly, the present invention relates to a system and method for automatic generation of presentation material by analyzing agenda and making use of an enterprise presentation database consisting of annotated analogical examples, templates, and slides.

### BACKGROUND OF THE INVENTION

Enterprises marketing their products and services meet regularly their clientele and prospects for business promotion purposes. Many times, there are several meetings with a client with different groups and to make the presentations more effective, the presentation material needs to be tuned keeping in mind the group profile. Lack of adequate time to manually prepare a presentation may force the presenter to make best use of his/her experience in delivering the presentation using a slightly out-of-date presentation material. This kind of mismatch between displayed content and articulated content could make the whole presentation somewhat ineffective. An alternative is to deploy a skilled team of professionals to help prepare the right presentation given the group profile. However, even in this case, there may be situations when this team of professionals is busy leading to the use of “what I have” presentation material. This establishes a need for an automatic generation presentation material based on group profile.

A matured or growing enterprise has a collection of presentations made over a period of time with varying successes. An automated system that could use this vast presentation base could help either individual presenters or a skilled team of presentation designers to quickly assemble an adequate number of slides in order that meets the client's expectations. On account of the nature and complexity involved with the automatic generation, it is worthwhile to explore a system that could manage a vast presentation base and generate a fairly acceptable draft version of the presentation material. This draft version can be fine tuned by a presenter, again taking as much assistance from the system as possible. A better organization of the presentation base can help (a) achieve using as much of the available information in as much effective manner as possible; and (b) provide fairly intuitive means of user interactions for fine tuning the presentations. The system can use the experience base of the enterprise in a systematic way by creating several templates that can be used under various circumstances. Templates are a well known way abstracting information for a wider applicability and some of the examples of templates include document template and drawing template. A template contains adequate information about (a) how to evaluate the suitability of a template for a given situation; (b) how to instantiate the various fields of a template with specific data; and (c) how to construct the desired object (such as document or drawing) using template as the basis. Using example presentations is yet another way of providing additional information to the system to help generate presentations for a given situation. Specifically, an example related to a similar situation is retrieved from the presentation base and used as the basis for presentation generation.

### DESCRIPTION OF RELATED ART

U.S. Pat. No. 6,148,330 to Puri; Deepak (San Francisco, Calif.); Yurica; Kevin (San Francisco, Calif.); Marshall; John (Saratoga, Conn.) for “System and method for automatically generating content for a network channel” (issued on Nov. 14, 2000 and assigned to Netscape Communications Corp. (Mountain View, Calif.)) describes a system and method for automatically generating content for distribution via a network channel.

U.S. Pat. No. 6,516,340 to Boys; Mark A. (Aromas, Calif.) for “Method and apparatus for creating and executing internet based lectures using public domain web page” (issued on Feb. 4, 2003 and assigned to Central Coast Patent Agency, Inc. (Aromas, Calif.)) describes a system for creating and conducting interactive lectures via the Internet or other wide-area networks.

U.S. Pat. No. 6,580,438 to Ichimura; Satoshi (Palo Alto, Calif.); Nelson; Lester D. (Santa Clara, Calif.); Pedersen; Elin R. (Redwood City, Calif.) for “Systems and methods for maintaining uniformity in a presentation environment” (issued on Jun. 17, 2003 and assigned to Fuji Xerox Co., Ltd. (Tokyo, JP)) describes a presentation control systems and methods that provide support for manipulating the context of elements within a presentation. Specifically, the systems and methods of this invention receive a request to display a presentation element, for example, a slide. The context of the slide is then manipulated in accordance with a style profile, or template, that can ensure a uniform display characteristic between presentation elements of varying formats.

U.S. Pat. No. 6,684,369 to Bernardo; Richard S. (Needham, Mass.); MacPhee; David A. (San Mateo, Calif.) for “Web site creator using templates” (issued on Jan. 27, 2004 and assigned to International Business Machines, Corporation (Armonk, N.Y.)) describes a software tool for use with a computer system for simplifying the creation of Web sites. The tool comprises a plurality of pre-stored templates, comprising HTML formatting code, text, fields, and formulas that are used during the creation of a web site.

The known systems do not address the issue of automatic generation of presentation material from agenda. The present invention provides with an automatic interactive system to users to input agenda to help generate draft version of a presentation. Also, the present invention provides for fine tuning of the generated draft version of the presentation. Further, the present invention proposes an approach for the generation of templates from “best” presentations.

### SUMMARY OF THE INVENTION

The primary objective of the invention is to achieve automatic generation of presentation material to enhance the effectiveness of presentations made to clients and prospects. This is achieved by exploiting the implicit knowledge of the various presentation designers of an enterprise in the form of templates and example presentations.

One aspect of the present invention is the management of agenda, audience, and slide details wherein presentation organizer manages the agenda details including theme of a meeting, participant details, and duration, audience details including information about people and their roles and responsibilities, and company details, and presentation slide details including textual and graphical contents, and their annotations.

Another aspect of the present invention is the management of annotations wherein the salient aspects of agenda, audience, slides, presentation examples, and presentation templates are described using a common dictionary describing people, products, and processes based on network and hierarchical representations.

Yet another aspect of the present invention is the draft presentation generation wherein a draft version of a presentation is generated using the most appropriate analogical presentation examples.

Another aspect of the present invention is an alternative way of draft presentation generation wherein a draft version of a presentation is generated using the most appropriate presentation templates.

Yet another aspect of the present invention is to provide a method for presentation tuning wherein a user interactively fine tunes the generated draft version of a presentation.

Another aspect of the present invention is to provide a method for template generation wherein a template is automatically generated based on a presentation.

Yet another aspect of the present invention is to provide a method for combining the roles and responsibilities of the participants of a meeting.

Another aspect of the present invention is to provide a method for selecting examples and templates from a database based on the roles and responsibilities of the participants of a meeting.

### BRIEF DESCRIPTION OF THE DRAWINGS

FIG. 1 depicts the architecture of the Automatic Presentation Generation (APG) system.

FIG. 2 depicts the key elements of APG system.

FIG. 3 depicts the main components of Presentation Organizer subsystem.

FIG. 3A depicts a typical workflow of APG system.

FIG. 4 provides a brief description of the various databases of APG system.

FIG. 5 describes the procedures related to Agenda management.

FIG. 6 describes the procedure related to Audience management.

FIG. 7 describes the procedure related to Slide management.

FIG. 8 provides a brief description of the additional databases of APG system.

FIG. 8A depicts the typical representation of a template.

FIG. 9 describes the procedure related to the generation of draft version of a presentation based on analogical examples.

FIG. 10 describes the procedure related to the combining of roles and responsibilities.

FIG. 11 describes the procedure related to the selection of examples based on combined roles.

FIG. 12 describes the procedure related to the combining of examples based on combined responsibilities.

FIG. 13 depicts the procedure related to the evolving of an initial draft version of a presentation.

FIG. 14 describes the procedure related to the generation of draft version of a presentation based on templates.

FIG. 15 describes the procedure related to the tuning of the generated presentation.

FIG. 16 describe the procedure related to the generation of templates.

FIG. 17 depicts the architecture of a network based APG system.

FIG. 18 depicts the interaction among multiple APGs.

### DETAILED DESCRIPTION OF THE PREFERRED EMBODIMENTS

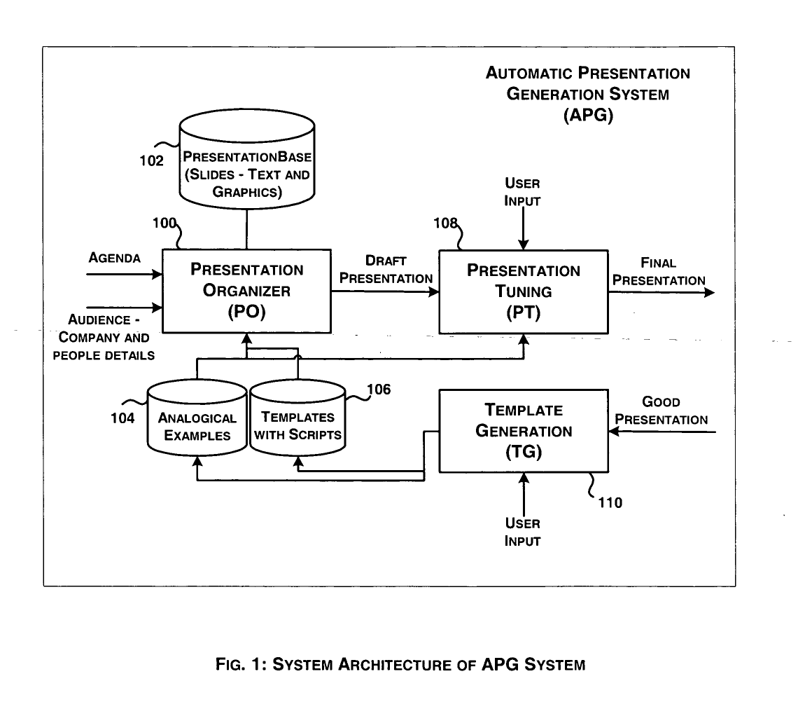

FIG. 1 depicts the system architecture of Automatic Presentation Generation (APG) system consisting of Presentation Organizer (PO), Presentation Tuning (PT), and Template Generation (TG) subsystems. The main objectives of APG system are to (a) organize the various presentation material within an enterprise; (b) construct a draft version of the presentation based on an agenda; (c) provide a framework for fine tuning of the generated presentation interactively by users; and (d) enhance the richness of stored presentation using the best presentations. Typically, in an enterprises, many presentations are made to visiting clients and prospects. These presentation are created manually by the staff members of the enterprise. Such a manual procedure depends on knowledge, skill, and experience of the individuals and these aspects typically vary from person to person. Furthermore, the quality of the presentation also depends on the amount of related information (such as past presentations and case studies) available. The APG system helps individuals by providing them with an almost acceptable draft presentation that can be tuned by using the same system. The generation of such a draft presentation is based on using as much of the past success stories as possible and this information is in the form of (a) example presentations; and (b) presentation templates. The relevant information from Presentation Base is selected based on agenda and audience profile. This helps identify those information that are most relevant and most recent in order to create an almost acceptable presentation material. The Presentation Base is organized in terms of slides and a slide is considered as the basic unit of a presentation material. There are two kinds of information that a slide can contain, namely, text and graphics. In order to assist in selection, slides are annotated and these annotation can be as much categorical as appropriate to help in achieving more accurate selection. During presentation tuning, the system provides help in the form of (a) selecting alternative slides for replacement; (b) selecting slides based on a more specific theme; (c) displaying slides that are similar to the selected slide; and (d) displaying equivalent text and graphic components based on a theme. Uses also interact with the system during template generation, based on best illustrative presentations, by appropriately providing (a) annotations; and (b) themes.

100 depicts Presentation Organizer (PO) subsystem that takes agenda and audience profile as input and with help of Presentation Base (102), analogical examples (104), and presentation templates (106) to generate a draft version of a presentation. 108 depicts Presentation Tuning (PT) subsystem that takes the generated draft presentation as input and interactively with appropriate user inputs generates a final version of the presentation. Finally, 110 depicts Template Generation (TG) subsystem that takes “best” presentation as input and interactively with appropriate user inputs and generates a presentation template that is stored in a database (106). Note that certain presentations are also stored in a database (104) to use the same as analogical examples during presentation generation process.

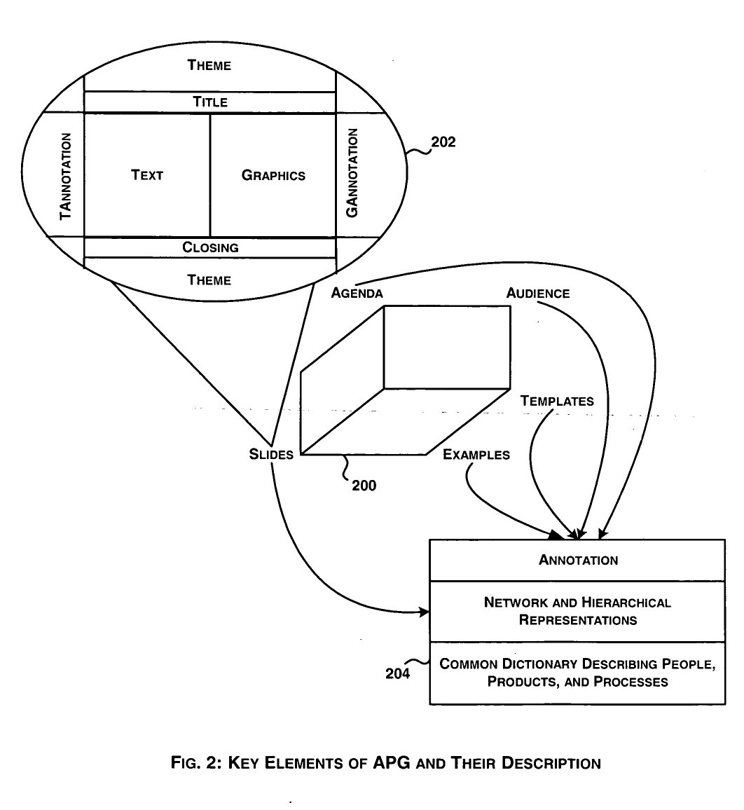

FIG. 2 provides a brief description of the various key elements of APG system. The system is based on five critical elements (200), namely, agenda, audience, slides, analogical examples, and templates. A typical slide consists of (a) opening title; (b) text; (c) graphics; and (d) closing remarks (202). All the key elements are annotated using a common dictionary of terms in order to help relate each other (204). Such relationships between terms are represented using hierarchical and network based structures and specifically, an annotation of a text portion or graphics portion of a slide is represented using hierarchical or network structure. The common dictionary describes the various attributes that are related to people, products, and processes. For example, audience information annotation makes use of people attributes to describe participants, process attributes to describe their roles, and client information is annotated using product related attributes.

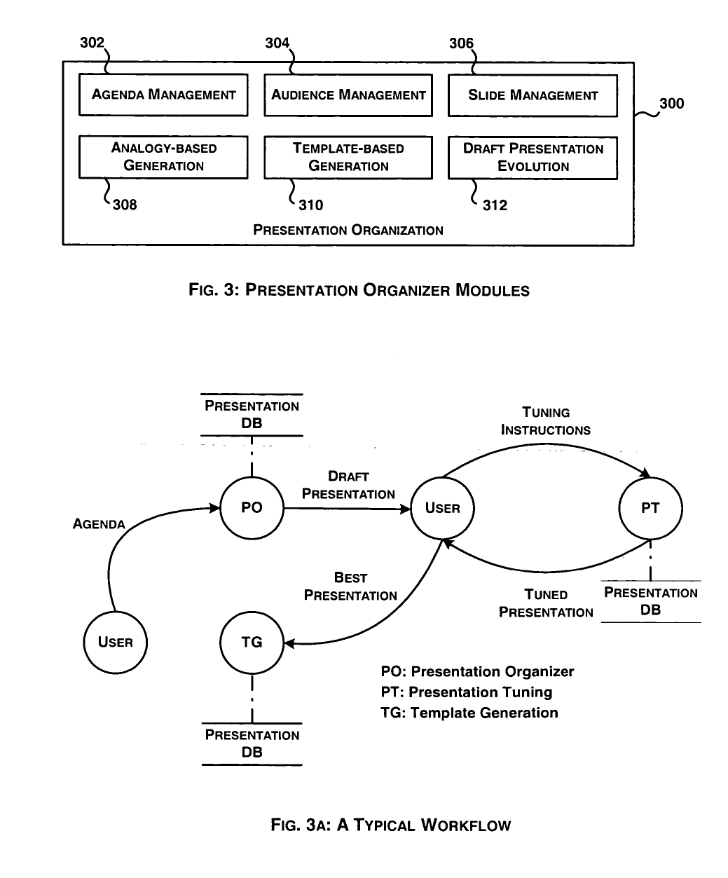

FIG. 3 describes the major modules of PO subsystem. There are six modules (300) and each performs a distinct functionality to collectively realize the overall functionality of PO subsystem. Agenda management module (302) manages the various agendas that are processed by APG system. The module also maintains a relationship between agenda and the generated presentations. Agendas are one of the important triggers for generating draft presentations. Note that, during the course of time, the agendas could get revised leading to the generation of new draft presentations. Audience management modules (304) deals with participants of a particular meeting, and their roles and responsibilities. As presentations are directed to audience, it is important to have accurate information with respect to the participants. Roles help in selecting the most suitable presentation examples from a database while responsibilities help in selecting the most appropriate slides from an example. Observe that an example may have multiple slides and not all of them are relevant given the roles and responsibilities of the participants. Slide management (306) manages the various slides that are part of the enterprise presentation base. Individual slides depicting various themes such as case studies are developed and are independently put into Presentation Base. Such a collection forms an important component of the enterprise's knowledge base. This module helps in creating and maintaining the slides with both text and graphics annotations and theme. Analogy-based generation module (308) generates several candidate presentations based on similar examples. Specifically, given an agenda and a theme, several example presentations contained in Analogical Examples database are identified and the appropriate ones are selected to subsequently generate the draft version of a presentation. Template based generation (310) is an alternative approach for generating draft version of a presentation. In this approach, based on an agenda and a theme, multiple templates from Templates database are selected and the best of the selected templates is used to help generate the draft version of a presentation. Finally, Draft Presentation Evolution (312) module refines the generated draft version of a presentation using slides present in Presentation DB to generate a refined draft version of a presentation.

FIG. 3a describes a typical workflow related to APG system. The workflow depicts the activities performed by a user and the major functions of the subsystems of APG system and indicates draft presentation generation and tuning, and the role of best presentations in template generation.

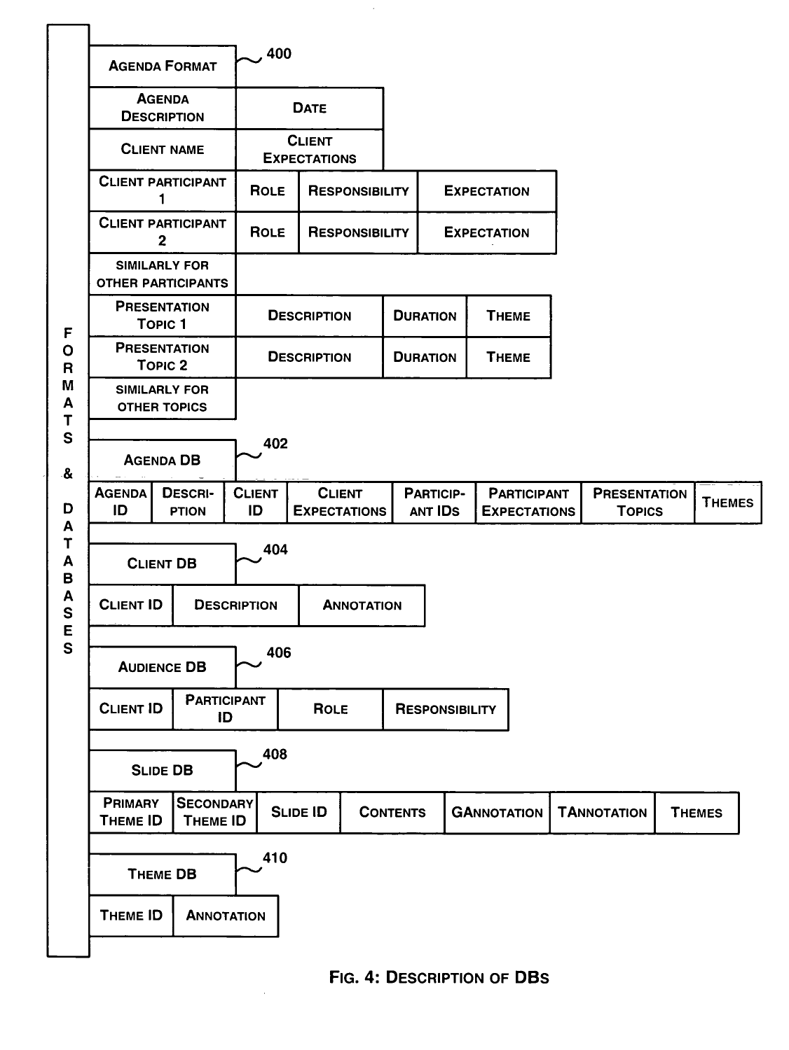

FIG. 4 provides a brief description of a few important elements of the major databases of APG system. 400 represents agenda information format and consists of information such as visiting client details, details of participants (such as their roles and responsibilities), and presentation details (such as topic and duration). 402 details agenda database that is based on the agenda information format. 404 represents client information related database and consists of information such as client description and annotation. The annotation is based on a common dictionary and provides structured information about the client. 406 provides audience related information and consists of information such as roles and responsibilities. 408 depicts information related to slide database and consists of information such as primary and secondary themes, text and graphics contents, and annotations. 410 represents information related to theme database and consists of information such as theme annotation. Note that all annotations are based on a common dictionary to enable the automatic processing and generation of presentations.

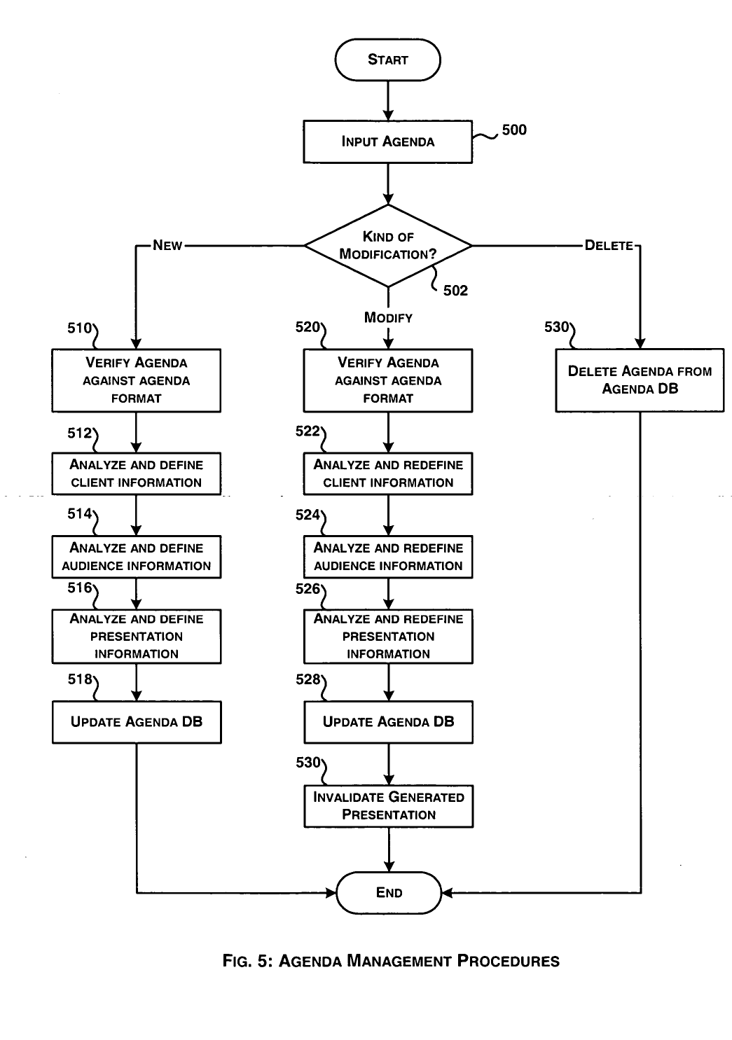

FIG. 5 describes the procedures related to agenda management. Agenda forms one of the important inputs (500) to APG system and different agendas maintained in the agenda database helps in relating generated presentations with agendas. If the input agenda is a new agenda (502), the agenda is validated for the information consistency (510) and is analyzed to extract client information (512). Further analysis is undertaken to obtain participant information, and their roles and responsibilities (514), and information related to presentation themes (516). The obtained information from the input agenda is used to update Agenda database (518). If the request is for modifying an existing agenda (502), the input changes are validated (520). The input is analyzed to obtain changes in client information (522), changes in audience information (524), and presentation information (526). The changes are updated onto Agenda database (528). If a presentation has already been generated based on old agenda, the same is invalidated to reinitiate the presentation generation process (530). If the request is for deleting an existing agenda (502), the input agenda is located in Agenda database and the same is deleted (530).

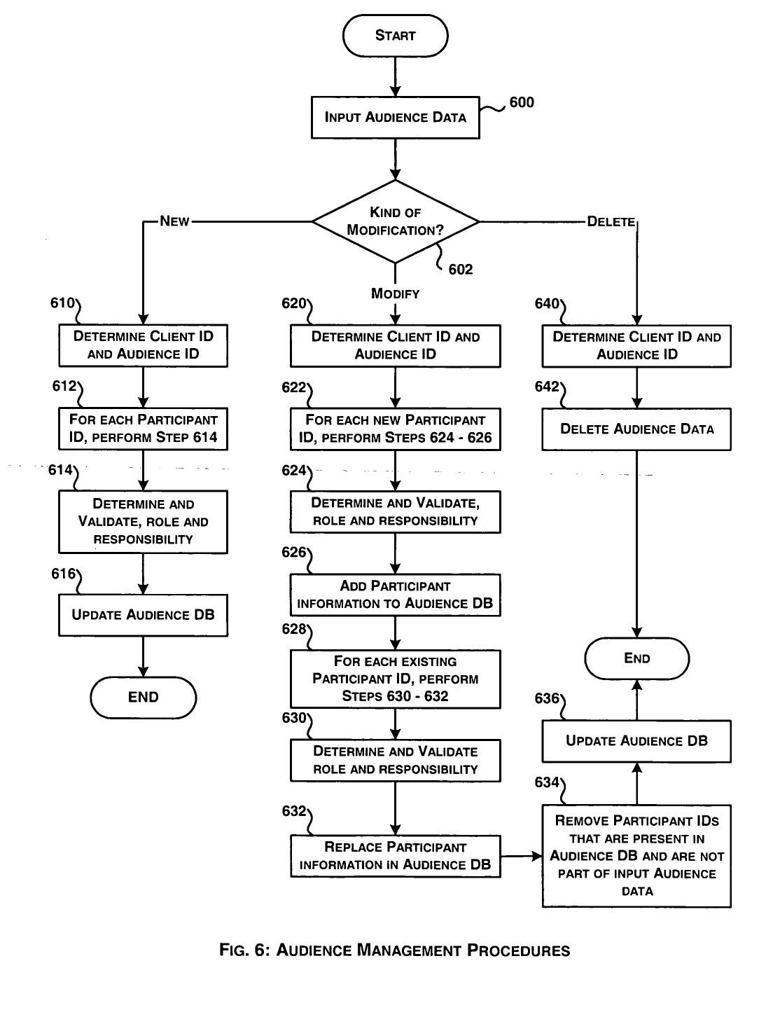

FIG. 6 describes the procedures related to audience data management. The input audience data (600) is analyzed and checked for the nature of request (602). If the request is related to new audience information, client and audience related information are obtained (610). For each participant that is part of the audience data, Step 614 is performed (612). The roles and responsibilities of a participant are validated using a role and responsibility hierarchy (614). The validated audience information is updated onto the audience database (616). If the request is related to the modification of an existing audience information (602), client and audience related information is obtained (620). For each new participant that is part of the audience data, Steps 624 and 626 are performed (622). In Step 624, the roles and responsibilities of a participant are identified and validated. The valid participant information is added to Audience database (626). For each existing participant that is already a part of audience database, Steps 630 and 632 are performed. In Step 630, the roles and responsibilities of a participant are identified and validated. The valid participant information is used to replace the corresponding information Audience DB (632). Remove any participant that is part of the audience database and is not part of audience data (634). The validated data is updated onto Audience database (636). If the request is related to the deletion of an existing audience data (602), audience data consisting of client and participant information are identified (640) and audience data is removed from the audience database (642).

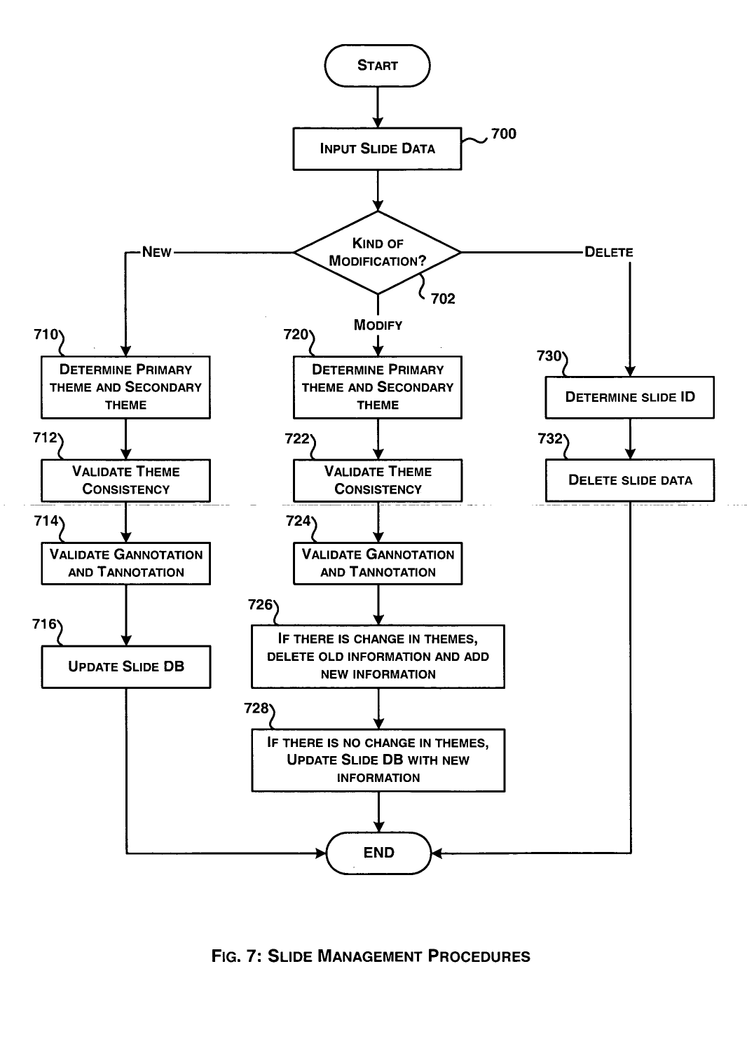

FIG. 7 describes the procedures related to slide data management. The input slide data and associated request is analyzed. If the request is related to a new slide data (702), primary and secondary themes related to the slide are determined (710). Note that each slide has a unique theme and this aspect is exploited while selecting a slide for making the same part of a presentation. The two themes (primary and secondary) are required to be consistent with each other and the input themes are analyzed for their consistency (712). Each slide can have either text portion alone, graphics portion alone, or both. And both text and graphics are annotated appropriately to capture the salient aspects of the slide. Note that these annotations are done manually and are associated with the slide. As both text and graphics convey the same theme, TAnnotation (text annotation) and GAnnotation (graphics annotation) should be consistent with each other and with respect to a common dictionary (714). The validated data in updated onto Slide database (716). On the other hand, if the requested action is to modify an existing slide data (702), primary and secondary themes are identified (720) and are validated for consistency (722). Further, GAnnotation and TAnnotation are validated with respect to each other and with respect to a common dictionary (724) and if there is change in theme information, the old information is deleted and new information is added onto Slide database (726). Otherwise, Slide database is updated with the validated information (728). If the requested action is to delete slide data (702), the corresponding slide ID is determined (730) and the slide data is deleted from Slide database (734).

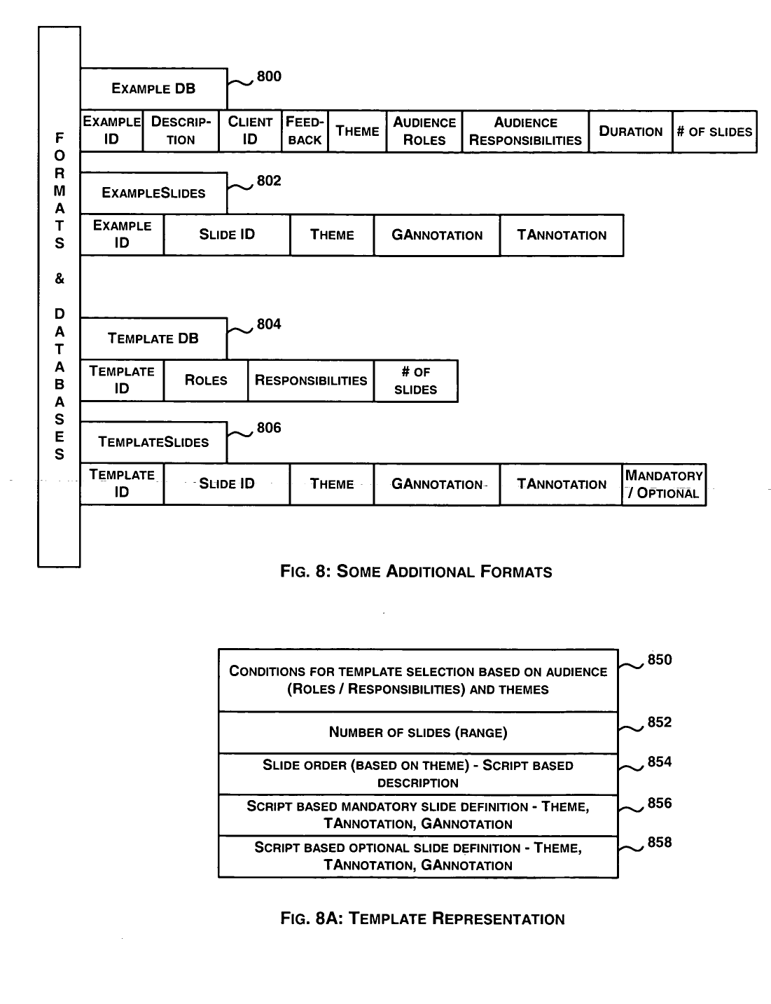

FIG. 8 provides a brief description of a few more databases of APG system. 800 represents Example database and consists of information such as client details, audience details, and presentation details. The Example database consists of typical presentations that are used as basis for generating draft presentations. The individual slides of an example presentation are stored in ExampleSlides database (802). 804 details template related information and consists of information such as roles and responsibilities. 806 provides the information related to the individual slides of a template.

FIG. 8A provides a brief description of template representation. A scripting language is used to describe the various aspects of a template. 850 depicts the conditions that enable the selection of a template based on information such as roles, responsibilities, and themes. Note that some templates can be generic and some can be specific, and this nature of a template is based on how loose/strict the conditions are. 852 describes the typical range of number of slides in the generated draft version of a presentation and based on presentation duration, an appropriate number of slides that is within the range is determined. Templates also provide guidance on slide order within a presentation (854). A slide defined within a template is either mandatory or optional. Mandatory slides defined within a template are a must in a presentation that is based on the template and is described using the various aspects of a slide such as Theme, TAnnotation, and GAnnotation (856). Optional slides defined within a template are optionally included in a presentation that is based on the template and is described using the various aspects of a slide such as Theme, TAnnotation, and GAnnotation (858).

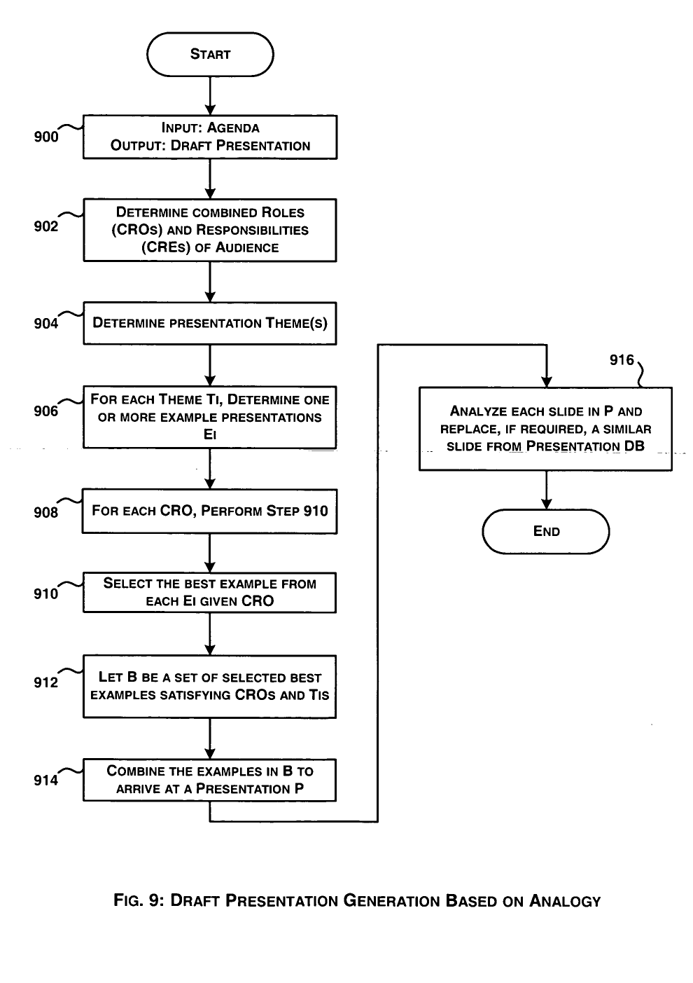

FIG. 9 describes the procedure for the generation of a draft presentation based on analogy. The draft presentation generation is based on an agenda (900). Agenda provides information about people who are likely participate in a meeting and it is appropriate that the presentation makes an impact on these participants. Hence, the roles and responsibilities provide the needed information to prepare a targeted presentation. Determine the roles and responsibilities of the audience and combine them appropriately using related hierarchical information (902). Such combined roles and responsibilities provide a generic description of multiple participants leading to the presentation with “right” content (instead of being too specific for one and totally unrelated for the rest). Many times multiple perspectives, based on multiple themes, are required to be covered in a presentation. Determine the theme or themes of the presentation (904). For each theme, determine one or more example presentations (906). The objective is to select those example presentations that are based on similar themes and further analyze the example presentations based on roles of the participants to select the best possible example presentations. This analysis is based on roles of the participants and for each of the combined roles of the participants (908), best of the theme based example presentations are selected (910). Determine the selected best examples satisfying both theme and roles (912). Combine the multiple best examples to arrive at a draft version of the presentation (914). Finally, analyze the slides in the generated draft presentation to incorporate better suited, most recent slides from the presentation base (916).

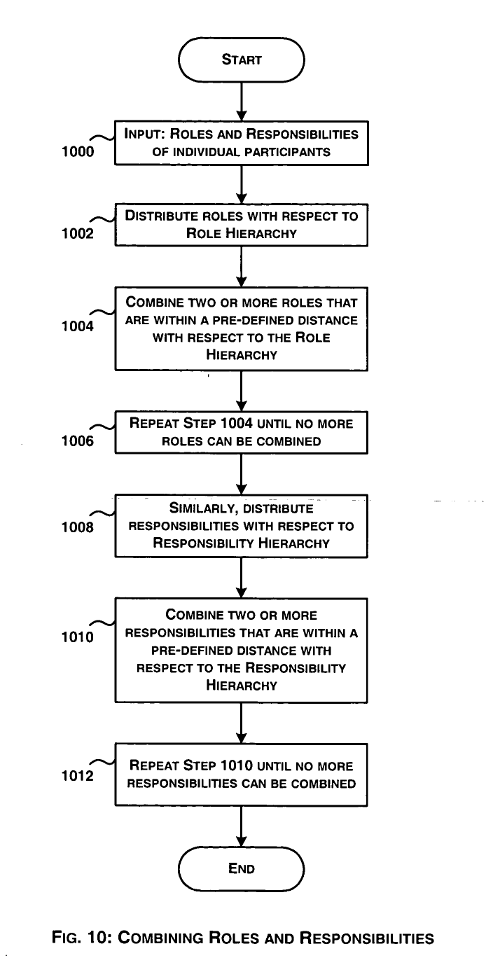

FIG. 10 describes the procedure for combining roles and responsibilities. Input is the roles and responsibilities of individual participants (1000). The objective in generating combined roles and responsibilities is to (a) avoid individual participant-wise processing; and (b) avoid generation of over focused or too specific presentations. The roles and responsibilities are combined by making use of respective hierarchies. As a first step, the roles of the participants are distributed with respect to a role hierarchy (1002). Based on the hierarchy, a notion of distance is defined with respect to the roles of the participants. Combine the two or more roles that are within a pre-defined distance from each other (1004). Such combining of roles is continued until all the roles are accounted (1006). Similarly, responsibilities are distributed with respect to a responsibility hierarchy (1008), and are combined (1010, 1012).

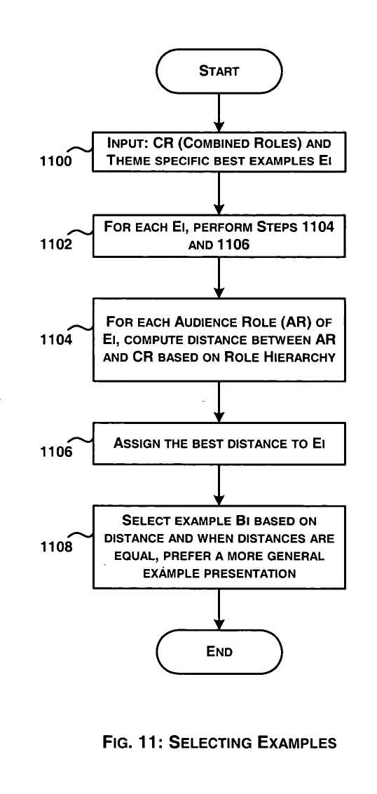

FIG. 11 describes the procedure for selecting example presentations based on the roles of participants. Each example presentation has related audience roles information and this information is used in the selection process. Input is a combined roles and a set of example presentations (1100). For each input example presentation (1102), perform Steps 1104 and 1106. Determine the distance between the combined role and role as described in the example presentation using a role hierarchy (1104). Due to the hierarchical nature of the relationship among the roles, the distance between to roles is defined as the path length between the two roles. Assign the weighted sum of distances between each of audience roles of an example presentation and the combined role as the best distance to the example presentation (1106). Finally, select one of the examples based on their closeness to the input role (1108).

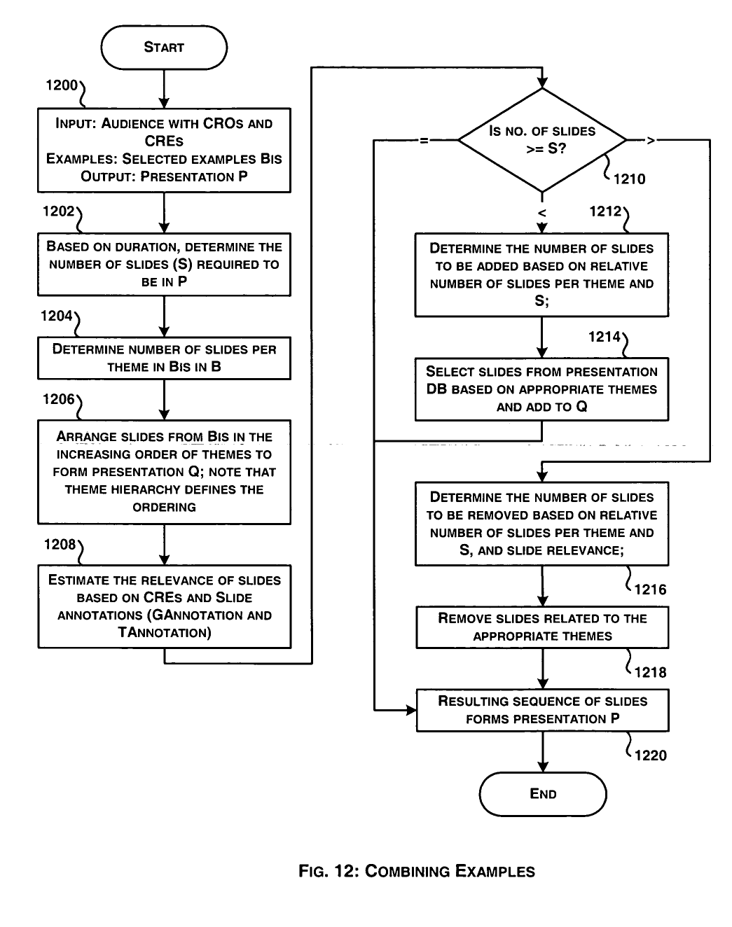

FIG. 12 describes the procedure for combining examples to form a draft version of a presentation. The objective is to combine several best presentations to arrive at the most suitable presentation. The combining is based on responsibilities of the participants (1200). The draft version of the presentation need to have the right number of slides and an approximate number of slides is determined based on the duration (1202). Each slide in each of the example presentations contains the slide theme and this gives an opportunity to combine the various slides of the various presentations. The number of slides per theme is determined (1204), and these slides are grouped based on the slide theme and ordered (1206). This grouping and ordering helps in a systematic processing of slides giving equal importance to the various themes. Estimate the relevance of the slides based on CREs and slide annotations, namely, TAnnotatoin and GAnnotation (1208). If there are lesser number of slides than what is approximately required (1210), determine the number of slides to be added based on relative number of slides per theme (1212). Select the slides from Presentation database based on these themes (1214). On the other hand, if the number of slides is more than what is approximately required (1212), determine the number of slides to be removed based on the relative number of slides per theme and slide relevance (1216) and remove them (1218). The resulting sequence of slides forms the draft version of the presentation (1220).

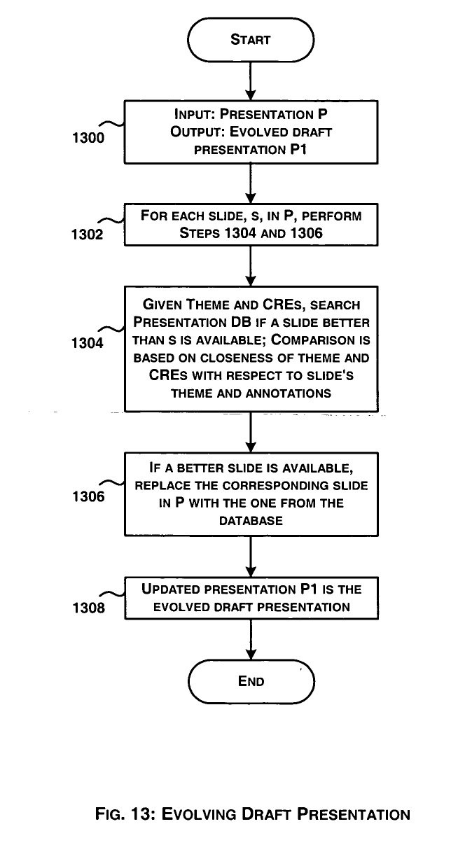

FIG. 13 describes the procedure for enhancing the generated draft version of a presentation. The objective is to use the slides that are part of the example presentations as the baseline and to search the presentation database for better equivalent slides. Input is the draft version of a presentation (1300). For each slide in the draft version of the presentation (1302), Steps 1304 and 1306 are performed. Based on slide theme and combined responsibilities of the participants, slides similar to a slide in the draft presentation are located in the presentation base (1304). The located slides are compared with the slide in the draft presentation based on annotations and themes. If one of the located slides is better, use the same to replace the slide in the draft presentation (1306). The updated the presentation is the evolved draft presentation (1308).

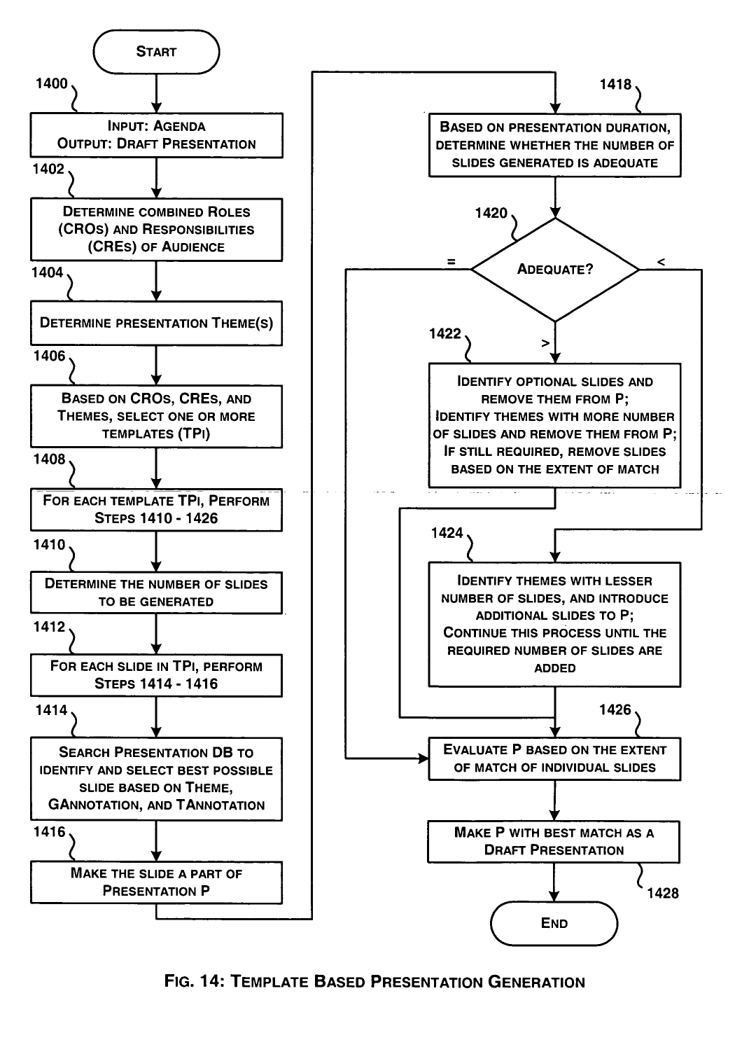

FIG. 14 describes the procedure for template based presentation generation. The input for template based presentation is an agenda for a meeting (1400). Based on the agenda, determine the combined roles and responsibilities of the participants (1402), and the presentation themes (1404). Search the template database using the combined roles and responsibilities, and themes, and determine the best possible templates (1406). For each of the best templates, perform Steps 1410 through 1426 (1408). Based on duration, determine the number of slides that are required to be part of the presentation (1410). For each slide in a template, perform Steps 1414 and 1416 (1412). Search presentation database to identify and select the best possible slide based on the (a) presentation theme; (b) slide theme; (c) TAnnotation; and (d) GAnnotation (1414). Make the best slide a part of the draft version of the presentation being generated (1416). Based on the presentation duration, determine whether the number of slides generated are adequate (1418). If more number of slides have been generated (1420), then identify optional slides and remove as many of them as necessary, identify themes with relatively more number of slides and remove as many of them as necessary, and identify slides with not so good match and remove as many of them as necessary (1422). On the other hand, if less number of slides have been generated (1420), identify themes with relatively lesser number of slides and introduce additional slides into the draft version of the presentation being generated (1424). Evaluate each of the generated presentation based on the extent of match of the individual slides (1426). Make the generated presentation with the best match as the draft version of the presentation (1428).

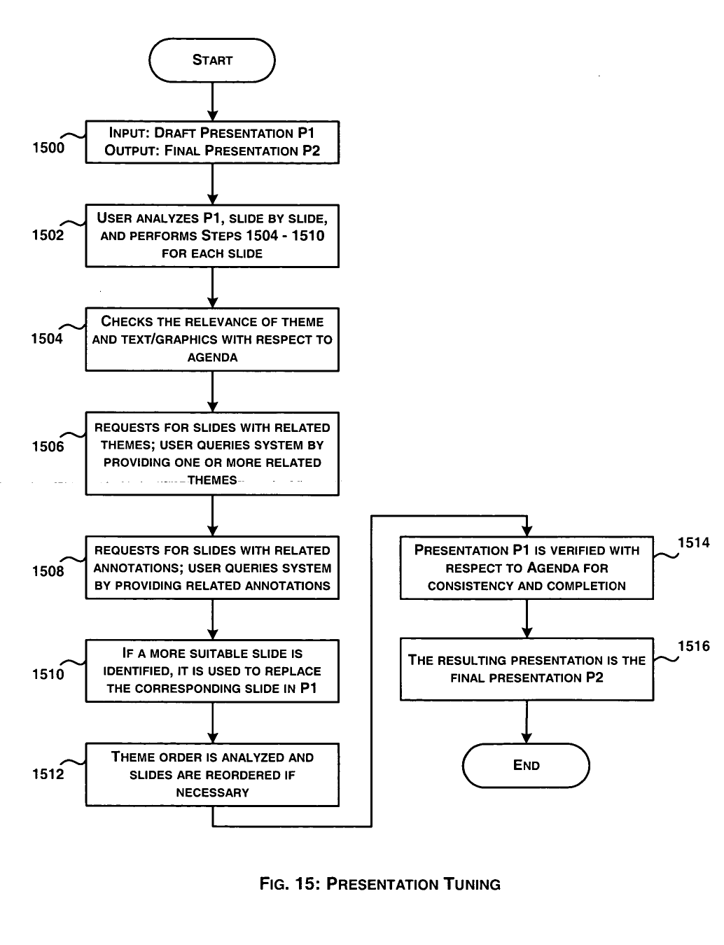

FIG. 15 describes the procedure for the interactive tuning of the generated draft version of a presentation by a user. The input for interactive tuning process is the draft version of a presentation and this process results in the generation of the final version of the presentation (1500). The user analyzes the draft presentation slide by slide and performs Steps 1504 through 1510 for each slide (1502). Each slide is checked for relevance of theme, TAnnotation, and GAnnotation with respect to the input agenda (1504). If required, the user requests for slides with related themes, and the system searches Presentation database and provides slides that best match the given themes (1506). Similarly, if required, the user requests for slides with related annotations, and the system searches Presentation database and provides slides that best match the given annotations (both text and graphics annotations) (1508). If a more suitable slide is identified, it is used to replace the corresponding slide in the draft presentation (1510). The order of slides in the draft presentation is analyzed with respect to theme order and slides are reordered if necessary (1512). Finally, the draft presentation is verified for consistency and completion with respect to the agenda (1514). The resulting presentation is the final version of the presentation (1516).

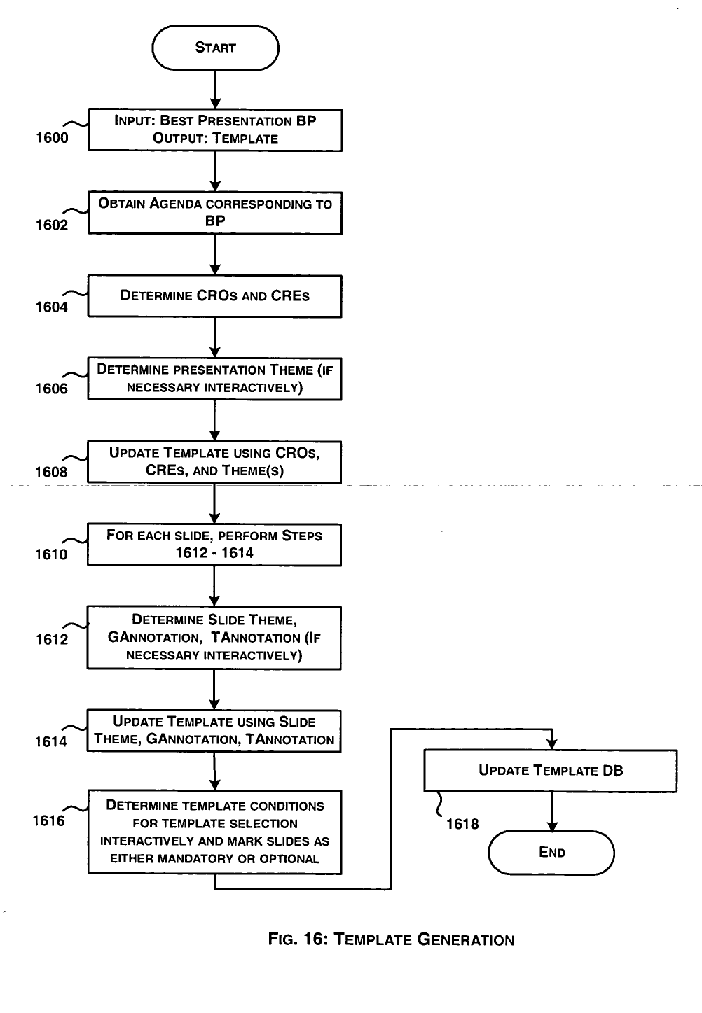

FIG. 16 describes the procedure for template generation. The template is generated by analyzing the input best presentation (1600). Obtain the agenda corresponding to the best presentation (1602) and determine the combined roles and responsibilities (1604). Determine the presentation theme(s), interactively if necessary (1606). Update the template using the combined roles and responsibilities, and the theme(s) (1608). For each slide, perform Steps 1612 and 1614 (1610). Determine the slide theme(s), TAnnotation, and GAnnotation, interactively if necessary (1612) and update the template appropriately (1614). The information such as number of slides, slide order, mandatory and optional aspects of the slides related to the template are updated. If there are conditions related to roles, responsibilities, and themes, the same are identified and updated onto the template, and the individual slides are marked as either mandatory or optional (1616). These conditions provide adequate information to select the most appropriate template(s) during draft presentation generation. Finally, the generated template is added to Template database (1618).

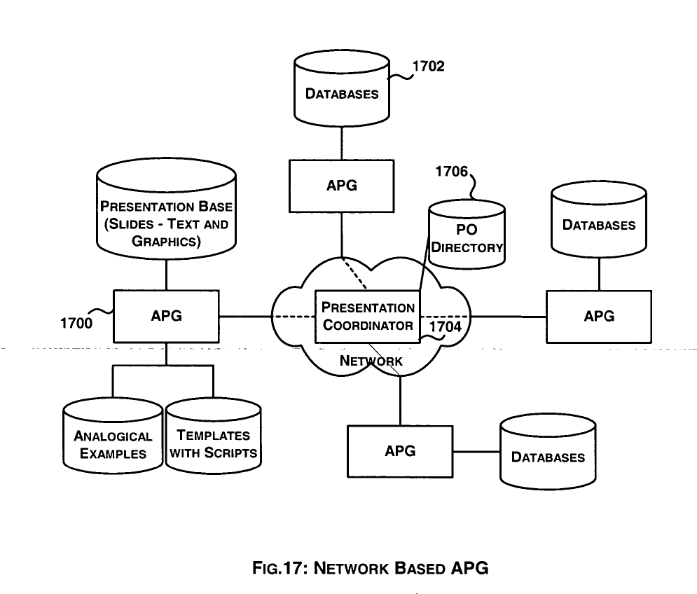

FIG. 17 describes the overall network architecture of a network-based APG. In such a system, there are multiple APGs (1700) each with its own presentation database. The presentation database consists of (a) information related to slides (text and graphics annotations); (b) analogical examples; and (c) templates (1702). The objective is to cater to the needs of a multi-office enterprise in which each office has an APG and at times, it is required to exploit the information contained in the presentation databases of other offices. The main functionality of Presentation Coordinator (1704) is to ensure that the multiple APGs can interact with each other to obtain the required slides, analogical examples, and templates, and this is achieved by making use of a directory database (1706) that contains information related to the distributed presentation databases.

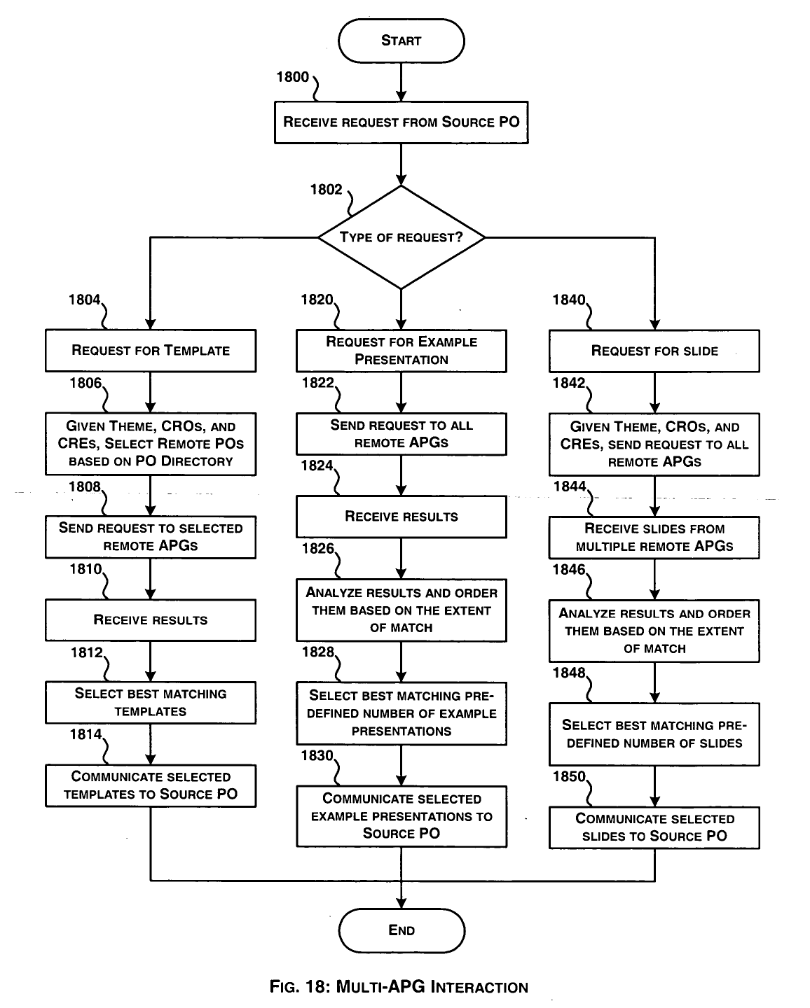

FIG. 18 describes the procedure for multi-APG interaction. Receive a request for information from presentation base of remote APGs from a source PO of an APG (1800). Analyze the type of request (1802) and if the request is for a template (1804), analyze the given roles, responsibilities, and themes with respect to PO directory (1806) and send the request to selected APGs (1808). Receive the results from the remote APGs (1810) and select the best possible template(s) (1812). One of the criteria for selection is the extent of match between input request and received results. Communicate the selected template(s) to the source PO (1814). On the other hand, if the request is for analogical examples (1820), send the request to all the remote APGs if PO directory does not contain enough information about example presentations (1822). Receive the results (1824), and analyze the results and order the example presentations based on the extent of match (1826). Select the best matching pre-defined number of example presentations (1828) and communicate the selected example presentations to the source PO (1830). If the request is for slides (1840), send the request (consisting of roles, responsibilities, and themes) to all the remote APGs (1842). Receive slides from multiple remote APGs (1844), and analyze the results and order them based on the extent of match (1846). Select the best matching pre-defined number of slides (1848) and communicate the selected slides to the source PO (1850).

Thus, a system and method for automatic generation of presentations based on annotated analogical examples, templates, and a collection of slides has been disclosed. Although the present invention has been described particularly with reference to the figures, it will be apparent to one of the ordinary skill in the art that the present invention may appear in any number of systems that perform automatic generation of presentations based on slides. It is further contemplated that many changes and modifications may be made by one of ordinary skill in the art without departing from the spirit and scope of the present invention.

1. A system for automatic generation of presentations based on annotated templates, analogical examples, and slides, said system comprising:
(a) a presentation organizer subsystem for analyzing input agenda and generating draft version of a presentation, said presentation organizer comprising: an agenda management element for managing agendas; an audience management element for managing participants of meetings; a slide management element for managing slides; an analogy based generation element for generating draft version of a presentation based on analogical examples; a template based generation element for generating draft version of a presentation based on templates; and a draft presentation evolution element for enhancing a draft version of a presentation; and
(b) a presentation tuning subsystem for interactively tuning a draft presentation; and
(c) a template generation subsystem for interactively generating templates from best presentations; and
(d) an analogical examples management subsystem for managing analogical examples; and
(e) a template management subsystem for managing templates; and
(f) an annotation subsystem for managing annotation of a plurality of key elements of said system comprising agenda, audience, slide, example presentation, and template.

2. The system of claim 1, wherein said agenda management element of said presentation organizer subsystem comprises means for processing of an agenda comprising format verification of said agenda, consistency verification of said agenda, analysis of client information of said agenda, analysis of audience information of said agenda, and analysis of presentation information of said agenda.

3. The system of claim 1, wherein said audience management element of said presentation organizer subsystem comprises means for processing of an audience information related to a client and a plurality of participants comprising consistency verification of roles and responsibilities of each of said plurality of participants, and consistency verification of roles and responsibilities of said plurality of participants with respect to said client.

4. The system of claim 1, wherein said slide management element of said presentation organizer subsystem comprises means for processing activities of a slide using a common dictionary comprising determination of a plurality of themes of said slide, consistency validation of said plurality of themes of said slide using said common dictionary, validation of annotation of textual portion of said slide using said common dictionary, validation of annotation of graphical portion of said slide using said common dictionary, and joint validation of annotation of textual portion of said slide and annotation of graphical portion of said slide using said common dictionary.

5. The system of claim 1, wherein said analogy based generation element of said presentation organizer subsystem comprises means for analogy based generation of a draft version of presentation related to an agenda comprising determination of a plurality of roles of a plurality of participants described in said agenda, determination of a plurality of responsibilities of a plurality of participants described in said agenda, determination of a plurality of themes based on said agenda, determination of a plurality of example presentations based on each of said plurality of themes, selection of a plurality of best presentations from said plurality of example presentations based on said plurality of roles, generating said draft presentation based on combining of said plurality of best presentations, and analyzing and conditionally replacing each slide of said draft presentation with a better, similar slide from a presentation database.

6. The system of claim 5, wherein said analogy based generation element further comprises means for combining a plurality of roles and combining a plurality of responsibilities, wherein said combining of said plurality of roles is based on a role hierarchy, and said combining of said plurality of responsibilities is based on a responsibility hierarchy.

7. The system of claim 5, wherein said analogy based generation element further comprises means for selecting a plurality of presentations from a plurality of example presentations, wherein said selection is based on audience role of each of said plurality of example presentations, a role, and a role hierarchy.

8. The system of claim 5, wherein said analogy based generation element further comprises means for combining a plurality of presentations, wherein each of said plurality of presentations consists of a plurality of slides, and wherein said combining is based on a plurality of themes, a plurality of responsibilities, an annotation of textual portion of each of said plurality of slides of each of said plurality of presentations, and an annotation of graphical portion of each of said plurality of slides of each of said plurality of presentations.

9. The system of claim 1, wherein said template based generation element of said presentation organizer subsystem comprises means for template based generation of a draft version of a presentation related to an agenda comprising determination of a plurality of roles of a plurality of participants described in said agenda, determination of a plurality of responsibilities of a plurality of participants described in said agenda, determination of a plurality of themes based on said agenda, selection of a plurality of templates based on said plurality of roles, said plurality of responsibilities, and said plurality of themes, identification of a plurality of slides from a presentation database based on a slide of a template of said plurality of templates, plurality of themes of said template of said plurality of templates, annotation of textual portion of each slide of a plurality of slides of said presentation database, and annotation of graphical portion of each slide of a plurality of slides of said presentation database.

10. The system of claim 1, wherein said draft presentation evolution element of said presentation organizer subsystem comprises means for enhancing a slide of a draft presentation related to an agenda comprising determination of a target slide from a presentation database based on a plurality of responsibilities of said agenda, theme of said slide, theme of said target slide, annotation of said slide, and annotation of said target slide, and replacement of said slide of said draft presentation by said target side based on extent match, wherein said match is based on theme of said slide, theme of said target slide, annotation of said slide, and annotation of said target slide.

11. The system of claim 1, wherein said presentation tuning subsystem comprises means for interactively tuning a slide of a plurality of slides of a draft presentation with respect to an agenda comprising validation of said slide based on theme of said slide, annotation of textual portion of said slide, annotation of graphical portion of said slide, and said agenda, selection of a replacement slide from a presentation database based on theme of said slide, annotation of textual portion of said slide, and annotation of graphical portion of said slide, and verification of consistency of said draft presentation based on said agenda.

12. The system of claim 1, wherein said template generation subsystem comprises means for interactively generating a template from a presentation related to an agenda comprising determination of a plurality of roles based on said agenda, determination of a plurality of responsibilities based on said agenda, determination of theme of said template based on said agenda and said presentation, determination of theme of a slide of said template based on theme of a slide of said presentation, determination of annotation of textual portion of a slide of said template based on annotation of textual portion of a slide of said presentation, determination of annotation of graphical portion of a slide of said template based on annotation of graphical portion of a slide of said presentation, and determination of a plurality of selection conditions for said template.

13. The system of claim 1, wherein said annotation subsystem comprises means for managing annotation of a plurality of key elements, wherein said annotation is based on network and hierarchical representations, and common dictionary describing people, products, and processes.

14. The system of claim 13, wherein said annotation subsystem further comprises means for annotating a slide comprising annotation of textual portion of said slide, annotation of graphical portion of said slide, and annotation of a plurality of themes of said slide.

15. A network based system for automatic generation of presentation based on a plurality of automatic presentation generations systems, said network based system comprising:
(a) a network for interconnecting said plurality of automatic presentation generation systems; and
(b) a presentation coordinator subsystem for managing interconnection of said plurality of automatic presentation generation systems.

16. The system of claim 15, wherein said presentation coordinator subsystem comprises means for coordinating requests from a plurality of automatic presentation generation systems comprising directory based routing of requests from an automatic presentation generation system of said plurality of automatic generation systems to a plurality of target automatic presentation generation systems of said plurality of automatic presentation generation systems based on a plurality of roles, a plurality of responsibilities, and a plurality of themes, selection of a plurality of templates based on a plurality of templates received from a plurality of automatic presentation generation systems of said plurality of automatic presentation generation systems, selection of a plurality of example presentations based on a plurality of example presentations received from a plurality of automatic presentation generation systems of said plurality of automatic presentation generation systems, and selection of a plurality of slides based on a plurality of slides received from a plurality of automatic presentation generation systems of said plurality of automatic presentation generation systems.
